(19) United States
(12) Patent Application Publication
(10) Pub. No.: US 2007/0188641 A1
(43) Pub. Date: Aug. 16, 2007

(54) Method and Image Sensor for Compensating for Reset Signal Levels of Active Pixels

(76) Inventor: Young-tae Jang, Suwon-si (KR)

Correspondence Address: F. CHAU & ASSOCIATES, LLC, 130 WOODBURY ROAD, WOODBURY, NY, 11797, US

(21) Appl. No.: 11/674,851

(22) Filed: Feb. 14, 2007

(30) Foreign Application Priority Data
Feb. 14, 2006 (KR) 10-2006-0014246

(51) Int. Cl. H04N 5/335

(52) U.S. Cl. 348/308

(57) ABSTRACT

Am image sensor includes an active pixel array, an optical black pixel array, and a reset level compensation unit. The active pixel array includes a plurality of active pixels. The optical black pixel array includes a plurality of optical black pixels. The reset level compensation unit compensates for the active reset signal levels output form the active pixels, according to the average value of the optical black reset signal levels output from the optical black pixels. An active reset signal having a stable level is output regardless of the distribution of the optical black pixels and the active pixels.

### CROSS-REFERENCE TO RELATED PATENT APPLICATION

This application claims the benefit of Korean Patent Application No. 10-2006-014246, filed on Feb. 14, 2006, in the Korean Intellectual Property Office, the disclosure of which is herein incorporated by reference in its entirety.

### BACKGROUND OF THE INVENTION

1. Technical Field

The present disclosure relates to an image sensor, and more particularly, to a method and an image sensor for compensating for reset signal levels of active pixels.

2. Discussion of the Related Art

An image sensor senses an image using a photodiode and outputs an image signal based on the sensed image. The level of the image signal output from the image sensor depends on a difference between a reset signal level and a signal level corresponding to an amount of charge stored on the photodiode.

In conventional image sensors, when a high-brightness object is picked up, a relatively large number of photoelectrons flow into the photodiode. When too many photoelectrons flow into the photodiode, the photoelectrons may overflow in the photodiode. The photoelectron overflow lowers the reset signal level of the conventional image sensor.

Accordingly, the image signal level output from the conventional image sensor as a result of the high-brightness object is lower than needed to accurately represent the image. For example, the color of an image, or part of the image, obtained when a high-brightness object is picked up appears darker than the original color of the high-brightness object, and may even appear black. For example, if the conventional image sensor picks up the sun, the color of the center part of the sun image becomes black.

### SUMMARY OF THE INVENTION

Exemplary embodiments of the present invention provide an image sensor for compensating for reset signal levels of active pixels. In compensating for reset signal levels, an average reset signal level for optical black pixels is used.

Exemplary embodiments of the present invention provide methods of compensating for reset signal levels of active pixels using an average reset signal level of optical black pixels.

According to an aspect of the present disclosure, an image sensor includes an active pixel array including a plurality of active pixels. The image sensor outputs a plurality of active reset signal levels. An optical black pixel array includes a plurality of optical black pixels. The optical black pixels output a plurality of optical reset signal levels. A reset level compensation unit compensates for the plurality of active reset signal levels according to an average value of the plurality of optical reset signal levels.

According to another aspect of the present disclosure, reset signal levels of active pixels in an image sensor may be compensated for. The image sensor includes an active pixel array including a plurality of active pixels. The image sensor outputs a plurality of active reset signal levels. An optical black pixel array including a plurality of optical black pixels and outputs a plurality of black reset signal levels. The method includes calculating an average value of the optical black reset signal levels output from the optical black pixels. The active reset signal levels output from the active pixels are compensated for according to the average value of the optical black reset signal levels.

### BRIEF DESCRIPTION OF THE DRAWINGS

The above and other features of the exemplary embodiments of the present invention will be described below with reference to the attached drawings in which:

FIG. 1 is a block diagram of an image sensor for compensating for reset signal levels of active pixels according to an exemplary embodiment of the present invention;

FIG. 2 is a detailed circuit diagram of the image sensor illustrated in FIG 1;

FIG. 3 is a circuit diagram of a reset level comparison unit illustrated in FIG.2;

FIG. 4 is a graph plotting a simulation result in which reset signal levels of active pixels included in the image sensor according to an exemplary embodiment of the present invention are compared with reset signal levels of active pixels included in a conventional image sensor;

FIG. 5A illustrates a resultant image obtained when the conventional image sensor picks up a high-brightness object;

FIG. 5B illustrates a resultant image obtained when the image sensor according to an exemplary embodiment of the present invention picks up a high-brightness object;

FIG. 6A is a view showing a process for obtaining the image illustrated in FIG. 5A;

FIG. 6B is a view showing a process for obtaining the image illustrated in FIG. 5B; and

FIG. 7 is a flowchart showing a method of compensating for reset signal levels of active pixels included in the image sensor illustrated in FIG. 1, according to an exemplary embodiment of the present invention.

### DETAILED DESCRIPTION OF THE EXEMPLARY EMBODIMENTS

Exemplary embodiments of the present invention will be described below with reference to the attached drawings. Like reference numerals in the drawings may denote like elements.

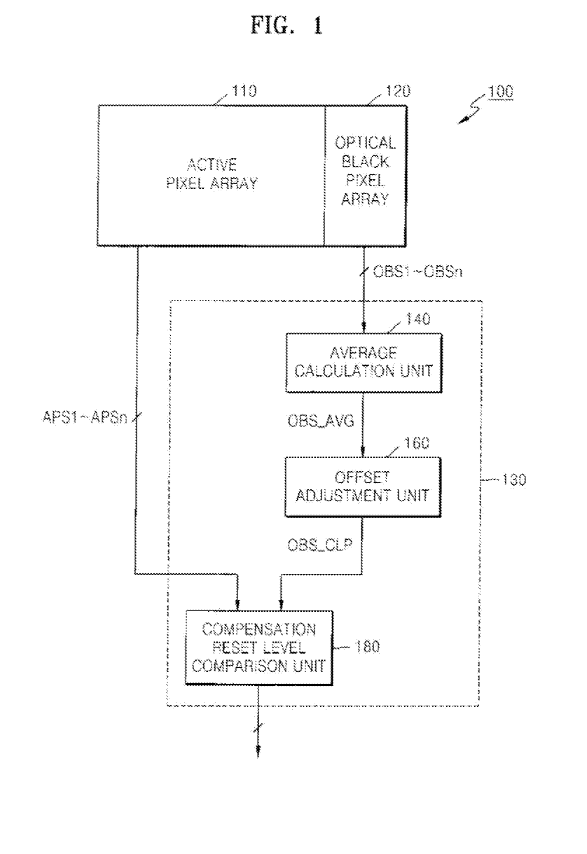

FIG. 1 is a block diagram of an image sensor 100 for compensating for reset signal levels of active pixels according to an exemplary embodiment of the present invention. The image sensor 100 uses an average value of reset signal levels of optical black pixels.

Referring to FIG. 1, the image sensor 100 includes an active pixel array 110, an optical black pixel array 120, and a reset level compensating unit 130. The active pixel array 110 includes a plurality of active pixels (not shown). The optical black pixel array 120 includes a plurality of optical black pixels (not shown). The reset level compensating unit 130 compensates for active reset signal levels APS1 through APSn output from the active pixels, according to an average value OBS_AVG of optical black reset signal levels OBS1 through OBSn output from the optical black pixels.

If each of the active reset signal levels APS1 through APSn is higher than the average value OBS_AVG of the optical black reset signal levels OBS1 through OBSn, the image sensor 100 outputs the active reset signal levels APS1 through APSn. If each of the active reset signal levels APS1 through APSn is lower than the average value OBS_AVG of the optical black reset signal levels OBS1 through OBSn, the image sensor 100 outputs a predetermined voltage.

For example, when each of the active reset signal levels APS1 through APSn is lower than the average value OBS_AVG of the optical black reset signal levels OBS1 through OBSn, each active signal level APS1 through APSn falls. Therefore, each of the active reset signal levels APS1 through APSn is raised to a predetermined voltage. For example, the predetermined voltage may be the maximum of the active reset signal levels APS1 through APSn.

The reset level compensating unit 130 includes an average calculation unit 140 and a compensation reset level output unit 180. The average calculation unit 140 calculates and outputs the average value OBS_AVG of the optical black reset signal levels OBS1 through OBSn. The compensation reset level output unit 180 compensates for the respective active reset signal levels APS1 through APSn, according to the results of comparison between the respective active reset signal levels APS1 through APSn and the average value OBS_AVG of the optical black reset signal levels OBS1 through OBSn, and outputs the results of the compensation as compensated reset signal levels. The image sensor 100 can further include an offset adjustment unit 160. The offset adjustment unit 160 may be included in the reset level compensating unit 130. The offset adjustment unit 160 adjusts the average value OBS_AVR of the optical black reset signal levels OBS1 through OBSn, and outputs the result of the adjustment to the compensation reset level output unit 180.

The image sensor 100 may be a complementary metal-oxide-semiconductor (CMOS) image sensor.

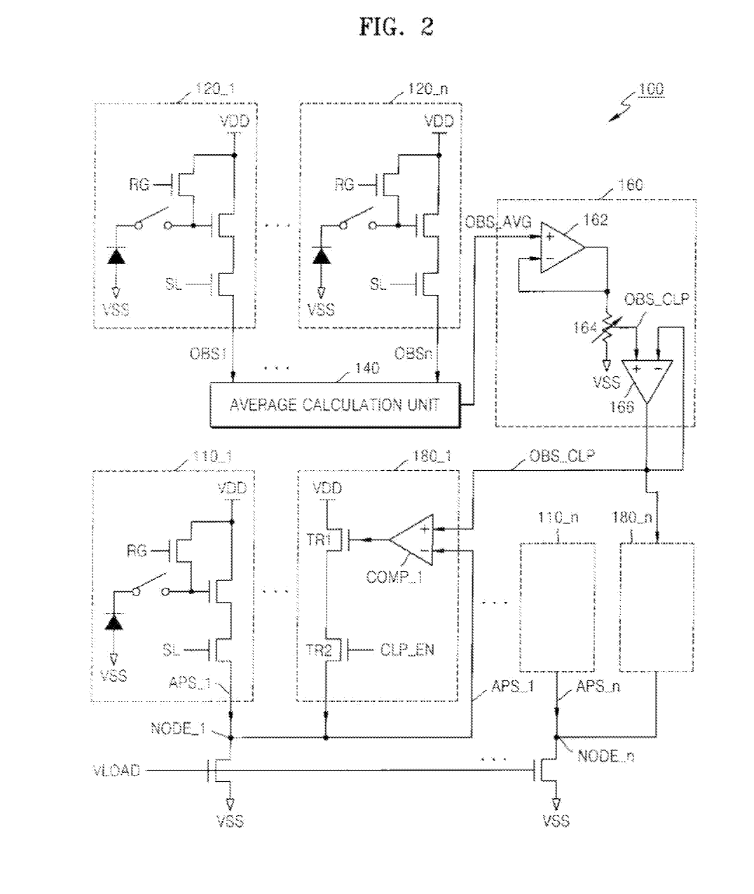

FIG. 2 is a circuit diagram of the image sensor 100 illustrated in FIG. 1.

Referring to FIG. 2, the active pixel array 110 includes a plurality of active pixels 110_1 through 110_n (not shown). The optical black pixel array 120 includes a plurality of optical black pixels 120_1 through 120_n. The compensation reset level output unit 180 includes a plurality of compensation reset level output devices 180_1 through 180_n (not shown). Each compensation reset level output device 180_1 through 180_n includes a comparison unit and two transistors. For example, the compensation reset level output device 180_1 includes a reset level comparison unit COMP_1, a first transistor TR1, and a second TR2.

The offset adjustment unit 160 includes a first buffer 162, a second buffer 166, and a variable resistor 164.

The operation of the image sensor 100 is described below with reference to FIG. 2. In FIG. 2, the n optical black pixels 120_1 through 120_n each have the same or similar structure, and perform the same or similar operation. The n active pixels 110_1 through 110_n have the same or similar structure, and perform the same or similar operation. The operation of the image sensor 110 is described below using a single optical black pixel 120_1 and a single active pixel 110_1.

The optical black pixels 120_1 through 120_n output optical black reset signal level OBS1 through OBSn, respectively. The average calculation unit 140 receives the optical black reset signal levels OBS1 through OBSn, and calculates and outputs the average value OBS_AVG of the optical black reset signal levels OBS1 through OBSn.

A variable resistor 164 of the offset adjustment unit 160 adjusts the average value OBS_AVG, and outputs an adjusted average value OBS_CLP. Here, the average value OBS_AVG may be equal to the adjusted average value OBS_CLP.

The active pixels 110_1 through 110_n output active reset signals APS1 through APSn to first through n-the nodes NODE_1 through NODE_n, respectively.

The reset level comparison unit COMP_1 compares the adjusted average value OBS_CLP with the active signal APS1, and outputs the result of the comparison. The first transistor TR1 is turned on or off according to the result of the comparison and outputs a predetermined voltage VDD. The second transistor TR2 is turned on or off according to a compensation enable signal CLP_EN and outputs the predetermined voltage VDD from the first transistor TR1 to the first node NODE1. The compensation enable signal CLP_EN is activated at a logical “high” level when the image sensor 110 compensates for the active reset signal levels of the active pixels 110_1 through 110_n.

For example, the active reset signal level APS_1 may be lower than the adjusted average value, OBS_CLP, which is equal to the average value OBS_AVG of the optical black reset signal levels OBS1 through OBSn. In this case, the reset level comparison unit COMP_1 outputs a “high ” signal. The “high ” signal is transferred to the gate of the first transistor TR1. Accordingly, the first transistor TR1 is turned on. When the first transistor TR1 is turned on, the supply voltage VDD is input to a first terminal of the second transistor TR2. The second transistor TR2 is turned on in response to a compensation enable signal CLP_EN which is “high. ” Accordingly, the second transistor TR2 outputs the supply voltage VDD to the first node NODE_1.

For example, the active reset signal level APS_1 may be higher than the adjusted average value OBS_CLP, which is equal to the average value OBS_AVG of the optical black reset signal levels OBS 1 through OBSn. In this case, the reset level comparison unit COMP_1 outputs a “low” signal. The “low ” signal is input to the gate of the first transistor TR1. Accordingly, the first transistor TR1 is turned off. When the first transistor TR1 is turned off, the second transistor TR2 does not output the supply voltage VDD to the first node NODE_1, regardless of the logical level of the compensation enable signal CLP_EN. As a result, the active reset signal level APS_1 is applied to the first node NODE_1.

Accordingly, if the active reset signal level APS_1 is higher that the average value OBS_AVG of the optical black reset signal levels OBS1 through OBSn, the image sensor 100 outputs the active reset signal level APS_2. If the active reset signal level APS_1 is lower than the average value OBS_AVG of the optical black reset signal levels, the image sensor 100 outputs the supply voltage VDD.

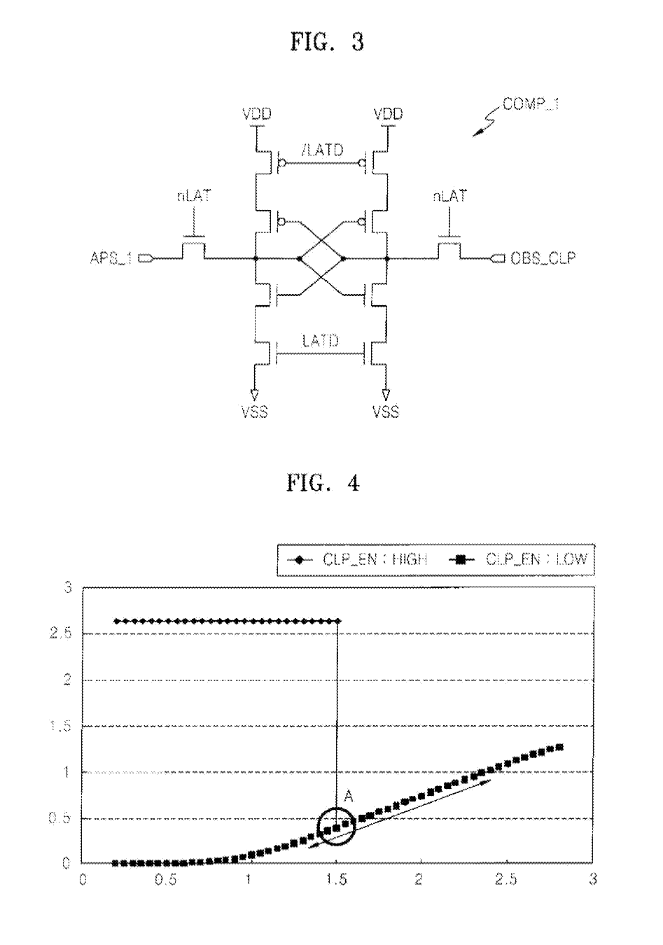

FIG. 3 is a circuit diagram of the reset level comparison unit COMP_1 illustrated in FIG. 2.

Referring to FIG. 3, the reset level comparison unit COMP_1 compares the adjusted average value OBS_CLP with the active reset signal APS, and outputs the result of the comparison. For example, if a signal nLAT is activated at a logical “high” level, then an adjusted average value OBS_CLP and an activated reset signal APS_1 are input from the reset level comparison unit COMP_1. The signal nLAT is deactivated at a logical “low” level. A signal LATD is activated at a logical “high” level, a signal /LATD is activated at a logical “low” level, and the adjusted average value OBS_CLP is compared with the activated reset signal APS_1.

FIG. 4 is a graph plotting a simulation result in which the reset signal levels of active pixels included in the image sensor 100 according to an exemplary embodiment of the present invention are compared with the reset signal levels of active pixels included in a conventional image sensor.

Referring to FIG. 4, if, for example, a compensation enable signal CLP_EN is “low,” the image sensor 100 does not compensate for the reset levels of the active pixels, and the reset levels of the active pixels fall.

If, for example, the compensation enable signal CLP_EN is “high,” the image sensor 100 compensates for the reset levels of the active pixels, and the reset levels of the active pixels are compensated to about 2.6V.

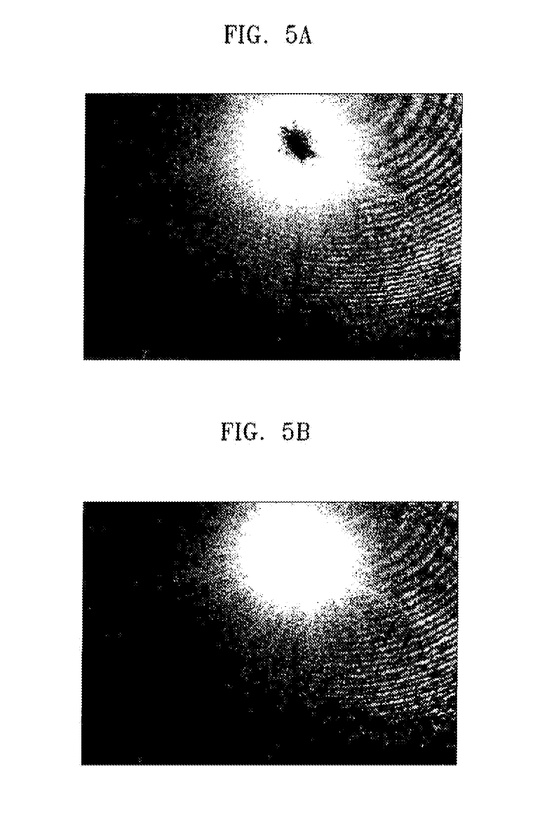

FIG. 5A illustrates an example of an image that may be obtained when the conventional image sensor picks up a high-brightness object.

FIG. 5B illustrates an example of an image that may be obtained when the image sensor 100 according to an exemplary embodiment of the present invention picks up a high-brightness object.

Referring to FIG. 5A, when the conventional image sensor picks up a high-brightness object, the color of a part of the high-brightness object appears black. Referring to FIG. 5B, when the image sensor 100 according to an exemplary embodiment of the present invention picks up a high-brightness object, the image of the high-brightness object appears in a normal state.

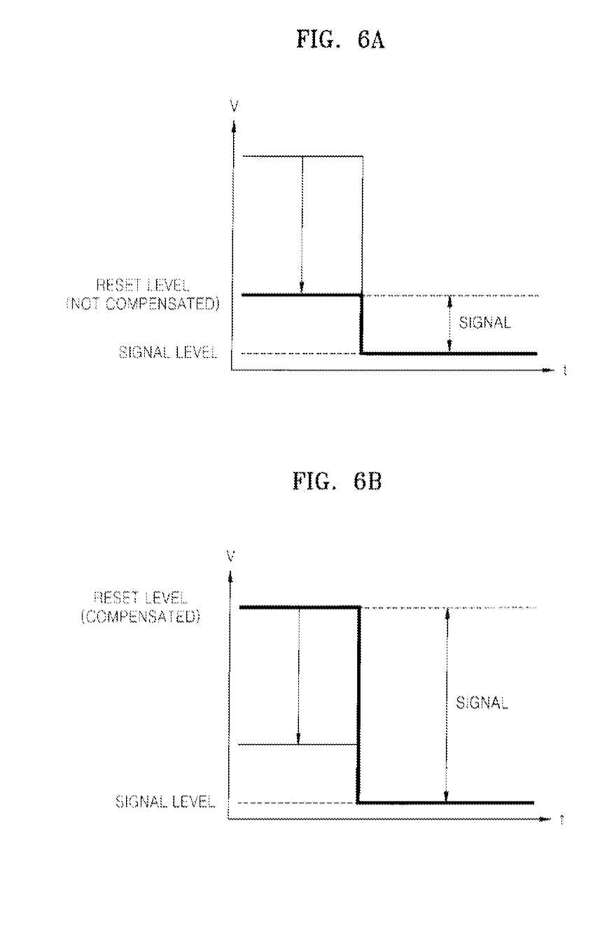

FIG. 6A is a view illustrating a process for obtaining the image illustrated in FIG. 5A.

FIG. 6B is a view illustrating a process for obtaining the image illustrated in FIG. 5B.

Referring to FIG. 6A, when the conventional image sensor picks up a high-brightness object, the reset signal levels of active pixels fall. Accordingly, the image signal levels of the high-brightness object output from the conventional image sensor become lower than the original image signal levels of the high-brightness object.

Referring to FIG. 6B, when the image sensor 200 according to an exemplary embodiment of the present invention picks up a high-brightness object, the reset levels of active pixels do not fall. Accordingly, the image signal levels of the high-brightness object output from the image sensor 100 according to an exemplary embodiment of the present invention are close or equal to the original image signal levels of the high-brightness object.

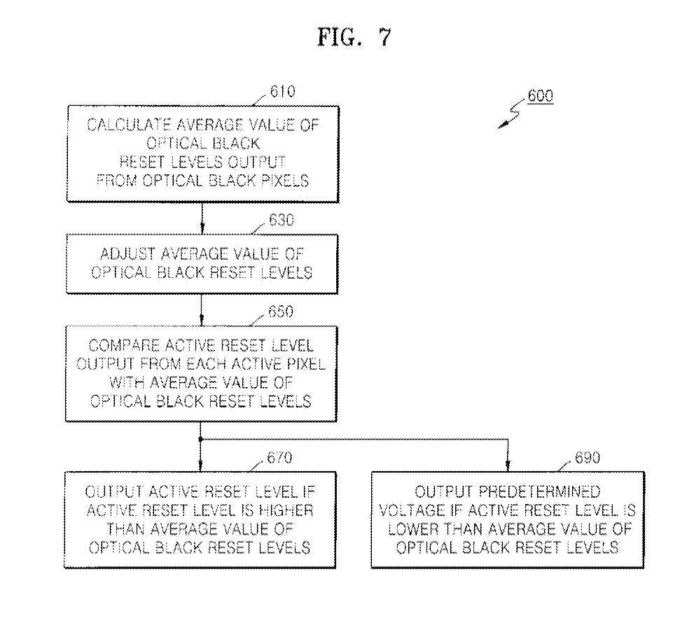

Fig. 7 is a flow chart illustrating a method 600 of compensating for the reset signal levels of active pixels in the image sensor 100 illustrated in FIG. 1, according to an exemplary embodiment of the present invention.

Referring to FIG. 7, the reset signal level compensating method 600 according to an exemplary embodiment of the present invention is used to compensate for reset signal levels in an image sensor. The image sensor includes an active pixel array including a plurality of active pixels and an optical black pixel array including a plurality of optical black pixels. The reset signal level compensating method 600 includes calculating the average value of optical black reset signal levels output from the plurality of optical black pixel (Step 610) and compensating for active reset signal levels output from the plurality of active pixels, depending on the average value of the optical black reset signal levels.

The operation of compensating for the active reset signal levels includes comparing an active reset level output from each active pixel with the average value of the optical black reset levels (Step 650). The active reset level is output if the active reset level is higher than the average value of the optical black reset levels (Step 670). A predetermined voltage is output if the active reset level is lower than the average value of the optical black reset levels (Step 690).

The reset signal level compensating method 600 includes adjusting the average value of the optical black reset levels (Step 630).

The reset signal level compensating method 600 discussed above shares many of the features of the image sensor discussed above. Therefore, the reset signal level compensating method 600 according to an exemplary embodiment of the present invention can be understood in light of the features discussed above.

As described above, an image sensor according to an exemplary embodiment of the present invention can output an active reset signal having a stable level, regardless of the distribution of optical black pixels and active pixels.

While exemplary embodiments of the present invention have been particularly shown and described with reference to the figures, it will be understood by those of ordinary skill in the art that various changes in form and details may be made therein without departing from the spirit and scope of the present invention.

What is claimed is:

1. An image sensor comprising:
an active pixel array including a plurality of active pixels, and outputting a corresponding plurality of active reset signal levels;
an optical black pixel array including a plurality of optical black pixels, and outputting a plurality of corresponding optical reset signal levels; and
a reset level compensation unit compensating the plurality of active reset signal levels, depending on an average value of the plurality of optical black reset signal levels.

2. The image sensor of claim 1, wherein the reset level compensation unit comprises:
an average value calculation unit calculating and outputting the average value of the optical black reset signal levels; and
a compensation reset level output unit comparing each active reset signal level with the average value of the optical black reset signal levels, compensating for each active reset signal level according to the result of the comparison, and outputting the result of the compensation as a compensated reset signal level.

3. The image sensor of claim 2, wherein the image sensor outputs each active reset signal level as the compensated reset signal level when the active reset signal level is higher than the average value of the optical black reset signal levels, and
the image sensor outputs a predetermined voltage as the compensated reset signal level when each active reset signal level is lower than the average value of the optical black signal levels.

4. The image sensor of claim 2, wherein the compensation reset level output unit comprises a plurality of compensation reset level output devices, each compensation reset level output device compensating for a corresponding active reset signal level of the plurality of active reset signal levels.

5. The image sensor of claim 4, wherein each of the compensation reset level output device comprises:
a reset level comparison unit comparing each active reset signal level with the average value of the optical black reset signal levels, and outputting the result of the comparison;
a first transistor responding to the result of the comparison, and outputting a predetermined voltage, and
a second transistor responding to a compensation enable signal, and outputting the predetermined voltage received from the first transistor.

6. The image sensor of claim 5, wherein, when each of the active reset signal levels is lower than the average value of the optical black reset signal levels, the first transistor is turned on and outputs the predetermined voltage, and when each of the active reset signal levels is higher than the average value of the optical black reset signal levels, the first transistor is turned off.

7. The image sensor of claim 3, wherein the predetermined voltage is a maximum value of the active reset signal levels.

8. The image sensor of claim 5, wherein the predetermined voltage is a maximum value of the active reset signal levels.

9. The image sensor of claim 1, further comprising an offset adjustment unit adjusting the average value of the optical black reset signal levels.

10. The image sensor of claim 1, wherein the image sensor is a CMOS (complementary metal-oxide-semiconductor) image sensor.

11. A method of compensating for reset signal levels of active pixels in an image sensor, the method comprising:
calculating an average value of a plurality of optical black reset signal levels output from a plurality of corresponding optical black pixels of an optical black pixel array of the image sensor; and
compensating for a plurality of active reset signal levels output from a plurality of corresponding active pixels of the image sensor, depending on the average value of the optical black reset signal levels.

12. The method of claim 11, wherein the step of compensating for each of the active reset signal levels comprises:
comparing each active reset signal level with the average value of the optical black reset signal levels;
compensating for each active reset signal level depending on the result of the comparison; and
outputting the result of the compensation as a compensated reset signal level.

13. The method of claim 12, wherein the step of outputting the compensated reset signal level comprises:
outputting the active reset signal level as the compensated reset signal level when each active reset signal level is higher than the average value of the optical black reset signal level; and
outputting a predetermined voltage as the compensated reset signal level when each active reset signal level is lower than the average value of the optical black reset signal levels.

14. The method of claim 13, wherein the predetermined voltage is a maximum value of the active reset signal levels.

15. The method of claim 11, further comprising adjusting the average value of the optical black reset signal levels.

16. The method of claim 11, wherein the image sensor is a CMOS image sensor. _
